(19) United States
(12) Patent Application Publication
(10) Pub. No.: US 2020/0047553 A1
(43) Pub. Date: Feb. 13, 2020

(54) Vehicle traction mat apparatus

(71) Applicants: Robert Harrington, Asheville, NC (US); Mackenzie Verdi, Boca Raton, FL (US)

(72) Inventors: Robert Harrington, Asheville, NC (US); Mackenzie Verdi, Boca Raton, FL (US)

(21) Appl. No.: 15/998,325

(22) Filed: Aug. 7, 2018

(51) Int. Cl. B60B 39/12

(52) U.S. Cl. CPC B60B 39/12

(57) ABSTRACT

A vehicle traction mat in the form of an elongated body member having a top surface with protruding upright gripper members or cleats for engagement by a vehicle wheel or tire includes supplemental openings in the top surface thereof for receiving additional or replacement gripper members and further includes a storage receptacle also located on the top surface for containing various accessories which may be required during use of the device such as cable ties for attaching a plurality of traction mats together to create a roadway, ground spikes for attaching the traction mat to the ground, and the aforementioned additional or replacement gripper members capable of being attached to the top of the traction mat as and when desired.

### FIELD OF THE INVENTION

The present invention relates generally to generally to vehicle wheel friction enhancement devices, and more particularly to a portable traction mat or tread for emplacement between the driven wheel of a vehicle when slippery ground conditions are encountered such as might be caused by ice, snow, mud, loose soil or the like.

### DESCRIPTION OF THE PRIOR ART

Many portable traction mat devices have been proposed in the past as exemplified by the following prior U.S. Pat. No. 2,225,828 (Godshall), U.S. Pat. No. 2,486,911 (Becker), U.S. Pat. No. 3,025,002 (Kunz), U.S. Pat. No. 3,342,414 (Jureit), and U.S. Pat. No. 3,836,075 (Botbol), each of which hereby is incorporated herein by this reference. While these devices generally are satisfactory for providing enhanced traction between the wheel of a vehicle under certain imperfect or adverse road or ground conditions, further room for improvement exits.

### BRIEF DESCRIPTION OF THE INVENTION

It is therefore a primary object of the present invention to provide an improved vehicle traction mat apparatus that advances the state of the art by combining in a unitary device several unique advantageous features unforeseen by the various traction mat devices of the prior art exemplified above. In brief, the traction mat of the present invention provides in combination: (i) an elongated molded plastic shell or body member having a top surface supporting rows of treads or cleats for engagement by the vehicle wheel or tire; (ii) inclined fore and aft edges for helping to wedge the mat between the ground and the wheel or tire; (iii) carry handles on the periphery of the body member, (iv) one or more rows of openings in the top surface for receiving additional or replacement tread or cleat elements; and (v) a storage receptacle located between the rows of cleats on the top surface for containing various accessories which may be required during use of the device such as cable ties for attaching a plurality of traction mats together to create a roadway, ground spikes for attaching the traction mat to the roadbed, and the aforementioned additional or replacement tread or cleat elements capable of being attached to the top of the traction mat as and when desired.

Another object of the present invention is to provide a novel vehicle mat traction device or apparatus of the foregoing type which is simple in its construction, comparatively inexpensive in its manufacture, thoroughly efficient and reliable in it use and operation, and otherwise well adapted to the purpose for which it is designed.

The above and numerous other objects of the invention will become evident from the following more detailed description of the invention, taken with reference to the annexed drawings.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a top plan view of the traction mat apparatus of the present invention.

FIG. 2 is a bottom plan view of the apparatus of FIG. 1.

FIG. 3 is cross-sectional view taken along line 3-3 in FIG. 1.

FIG. 4 is a schematic elevational view showing a vehicle in use with the traction mat of the present invention.

FIG. 5 is a top plan view schematically showing a pair of traction mat members attached together by cable ties to create a roadway.

FIG. 6 is a top plan view schematically showing a pair of traction mat members attached together by cable ties side-by-side for use with dual-wheel vehicles.

FIG. 7 is a side elevational view schematically showing a pair of traction mat members being stacked together for easy compact storage.

FIG. 8 is an enlarged fragmentary perspective view of the top of the traction mat of FIG. 1 showing the treads or cleats protruding from the top surface thereof among other features.

FIG. 9 is an exploded perspective view schematically showing an additional tread or cleat being fastened in its associated reception opening in the top wall of the traction mat of the invention.

### DESCRIPTION OF THE PREFERRED EMBODIMENTS

With reference to the drawings, a new and improved vehicle traction mat apparatus embodying the principles and concepts of the present invention now will be described.

Turning initially to FIGS. 1-4, 8 and 9, there is shown a preferred embodiment of the vehicle traction mat apparatus of the invention generally designated by reference numeral 10. In each of the Figures, reference numerals are shown that correspond to like reference numerals that designate like elements shown in other Figures.

In accordance with the preferred embodiment illustrated, our vehicle traction mat apparatus comprises a substantially rectangular-shaped tread member in the form of a shell or body member generally represented by reference sign 10. Shell member 10 is characterized by a raised top wall 12, a pair of fore and aft opposed inclined end walls or ramps 14, 16, and a pair of opposed inclined side walls 18, 20, substantially as depicted. Preferably, shell member 10 is fabricated of a stiff, durable molded polymeric material, with glass-filled nylon being mostly preferred, although other suitable material may be used as well.

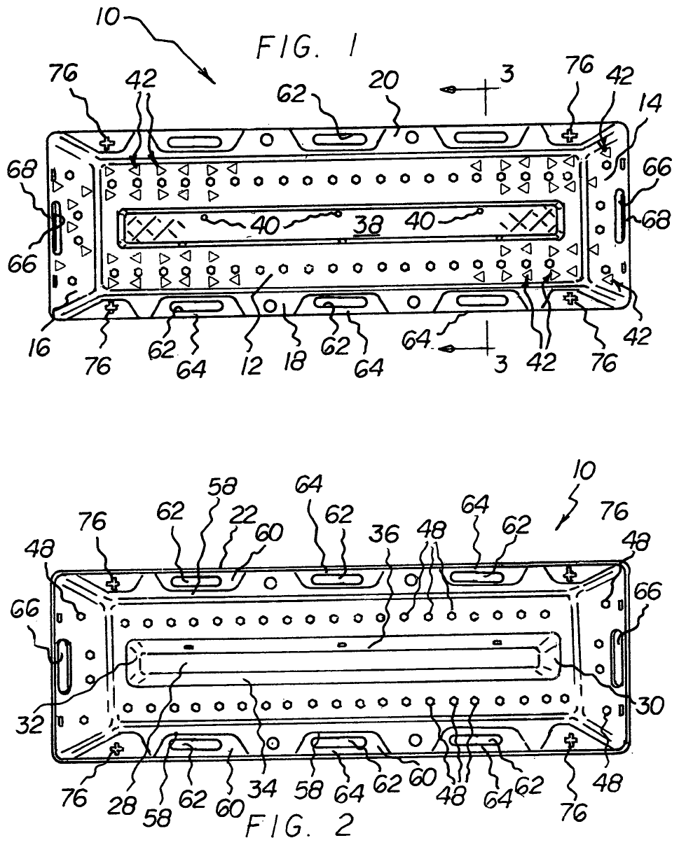

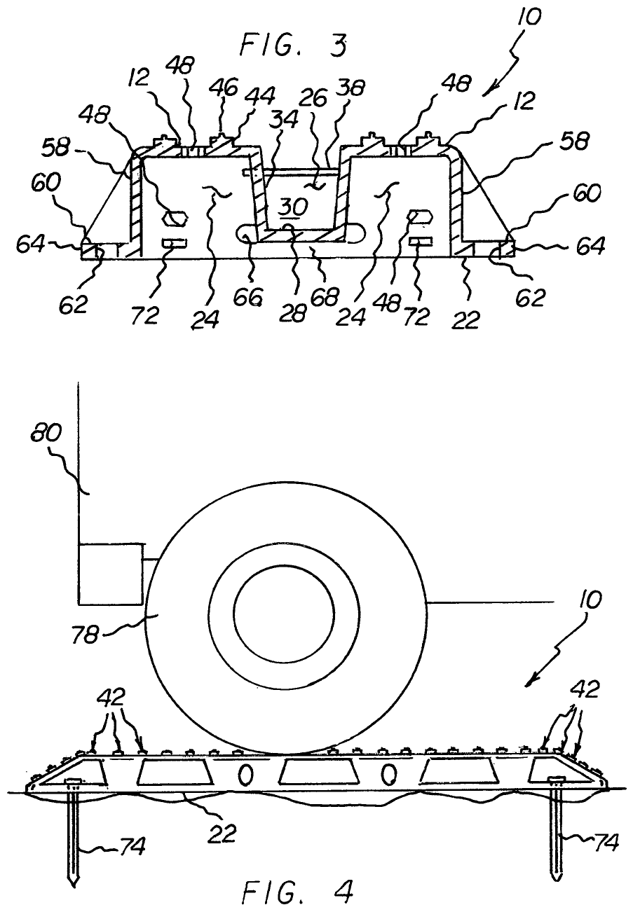

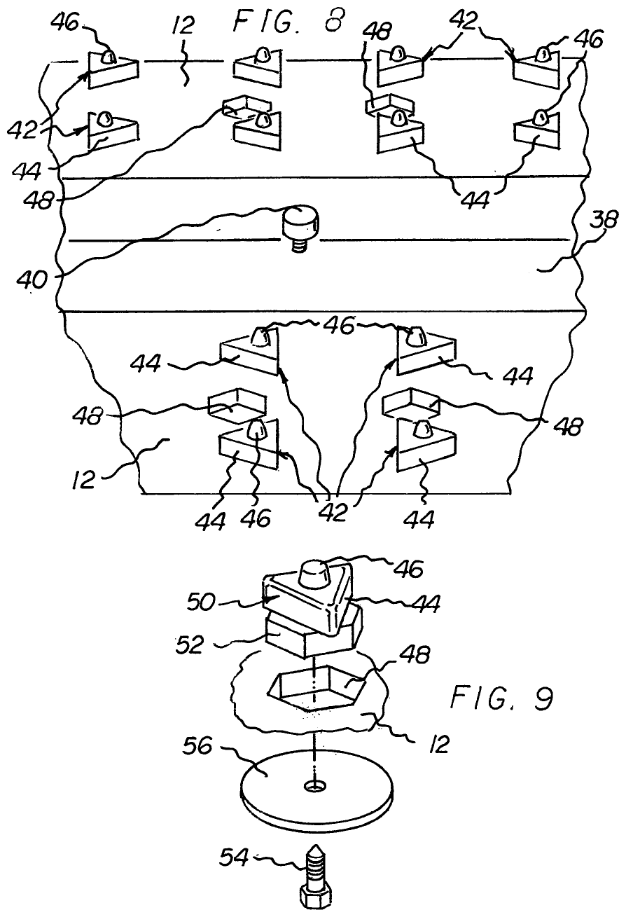

The bottom of the shell member 10 is generally concave and is bounded peripherally by a continuous annular ground-engaging rim 22. Thus top wall 12 extends longitudinally along the top of the tread in raised disposition with respect to rim 22 to define an interior space 24 underneath the top wall bounded by the top wall 12 and the opposed side walls 18, 20 (FIG. 3). In accordance with an important feature of the invention, a storage compartment or receptacle 26 depends downwardly from the top surface defined by top wall 12 and protrudes into interior space 24, substantially as depicted. Storage compartment 24 has a bottom wall 28, first and second opposed end walls 30, 32, and first and second opposed side walls 34, 36 integrally molded to and forming part of top wall 12 (FIGS. 2 and 3). The storage compartment 24 is located centrally on the imaginary central axis (not shown) of traction mat body shell 10 and spans almost the full longitudinal extent of the top wall 12 as substantially depicted in FIGS. 1 and 2. A substantially flat, removable cover 38 for the storage compartment 24 is fastened between side walls 34, 36 and end walls 30, 32 in a slightly recessed disposition relative to top wall 12 by a series of three spaced thumb screws 40 (FIGS. 1 and 8). The purpose of the storage compartment is to store accessories for the traction mat as will be explained in more detail below.

The central location of storage compartment 24 divides the top wall 12 into two substantial parallel spaced “tread sections” upon which are disposed a series of spaced “molded in place” protruding gripper elements 42 for suitably frictionally engaging the tire of a vehicle wheel. Similar gripper elements 42 are disposed in a suitable spaced array on the inclined end walls or ramps 14, 16. Each gripper element has a base portion 44 characterized by a generally triangular-shaped transverse cross-section and a protruding spike member 46 extending upwardly from base portion 44 generally centrally thereon.

Preferably, the spaced protruding gripper elements 42 are disposed in spaced juxtaposed rows, two on either side of the storage compartment 24, as best seen in FIG. 8. Also, it will be noted, to enhance friction between the rows of gripper elements 42 and the vehicle tire, each successive pair of gripper elements 42 in a given row preferably is oriented such that opposed flat sides on the adjacent base portions in such successive pair confront each other, respectively, and are disposed substantially orthogonally with respect to the longitudinal axis of the shell member 10 and the direction of each such row (FIG. 8). That is, the confronting base portion sides are generally parallel to each other whereas the apex portions on each base portion opposite to such base portion sides, respectively, point oppositely and away with respect to each other in alignment with the longitudinal axis of the shell member 10.

In accordance with another important feature of the invention, top wall 12 includes a plurality or series of hexagonally-shaped spaced through-openings 48 extending longitudinally along top wall 12 between the spaced rows of protruding gripper elements 42 and essentially parallel thereto with one such hexagonally-shaped opening being located between each pair of juxtaposed adjacent gripper elements 42 from the two adjacent rows, respectively (FIGS. 3 and 8). Similar hexagonally-shaped through-openings 48 suitably are provided in end walls or ramps 14, 16, respectively.

As a result of the foregoing arrangement, “supplemental” gripper elements indicated generally by reference sign 50 (FIG. 9) can be provided for selective fastening attachment to the top wall 12 and/or end walls 14, 16. Each supplemental gripper element 50 comprises a molded module consisting of the usual triangular-shaped base portion 44 and upwardly protruding spike member 46, but further includes a downwardly depending hexagonally-shaped sub-base member 52 molded to the bottom of base portion 44, substantially as depicted in FIG. 9. Sub-base member 52 is sized suitably to be loosely, but snuggly fitted within hexagonally-shaped through-openings 48 in top wall 12 or end ramps 14, 16. The module 50 can then be fastened in place as desired suitably using bolt fastener 54 and washer 56 and tightening these parts together from the underside of shell member 10 via a suitably tapped central opening (not shown) in the underside of sub-base member 52. In this manner, the supplemental gripper element modules 50 may be used to “retread” the top surface of top wall 12 and/or end walls 14, 16 when and if one or more original molded protruding gripper elements 42 become worn from use.

To facilitate handling the traction mat apparatus in the field, the shell member is equipped with a series of convenient carry handles. Substantially as depicted, each inclined side wall 18, 20 includes a series of three evenly spaced molded-in-place “pockets,” each comprising a vertical wall portion 58 and an intersecting flat, horizontal “foot portion” 60. A suitable oblong through opening 62 provided in each foot portion 60 defines a “side” carry handles 64 comprising the outward extremity of each foot portion bordering each oblong opening 62, respectively (FIG. 3). Similarly, each end wall 30, 32 respectively includes a suitable oblong opening 66 substantially as depicted (FIGS. 1-3) to define “end” carry handles 68 at opposed ends of the traction mat shell member 10, respectively.

In accordance with yet another important feature of the invention, “side” carry handles 64 serve the dual function of defining anchoring points for using conventional cable ties 70 or the like to connect two or more traction mat body shells 10 together in a juxtaposed or side-to-side configurations suitable for a vehicle having a dual-drive-wheel set-up (FIG. 6).

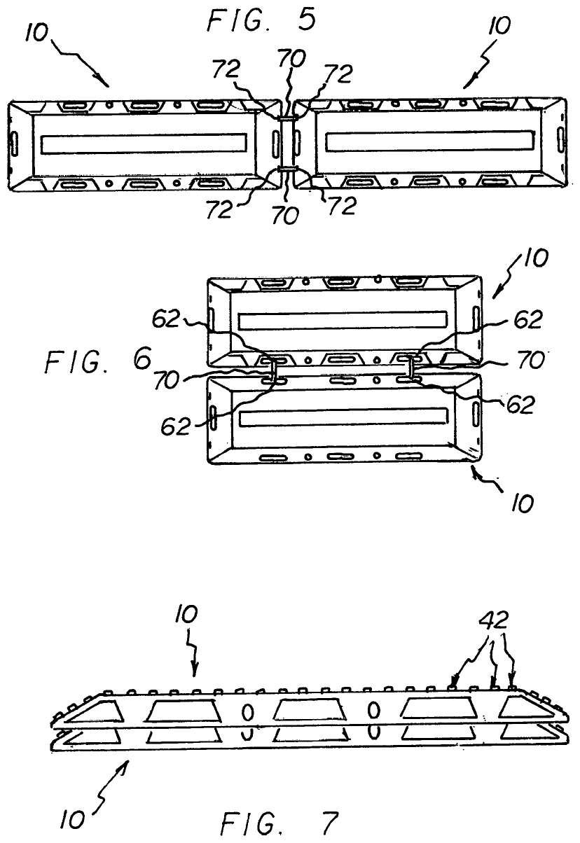

End walls 30, 32 preferably have supplemental openings 72, respectively, for receiving cable ties 70 when it is desired to connect one or more of the body shells together end-to-end to create a roadway for a vehicle wheel. This arrangement is schematically shown in FIG. 5.

To help secure the traction mat of the present invention on a roadbed, ground spikes 74 may be provided substantially as depicted in FIG. 3. Each ground spike 74 preferably has a crossed-rib transverse cross-sectional shape substantially as shown to increase its gripping ability in soil or below ground. Correspondingly, a series of complimentary-shaped through openings 76 are provided in side walls 18, 20 proximal to each corner of shell member 10, respectively, to receive the ground spikes (FIGS. 1, 2, and 4).

By virtue of its one-piece molded construction and dished bottom characteristic, a plurality of traction mat body members 10 can be conveniently stacked together vertically in a compact manner to save storage space. This advantageous “storage mode” arrangement is schematically depicted in FIG. 7. It will be appreciated in accordance with the invention, that when the traction mat body members are in “storage mode,” the storage compartment can be used to store the cable ties 70, grounds spikes 74, or other accessories.

In use, the traction mat shell or body member 10 can be used as a convenient shovel with one of the inclined end walls or ramps 14, 16 being used to remove snow, mud, loose soil or the like in the vicinity of a mired wheel/tire 78 on a vehicle 80. One of the body member's end walls or ramps 14, 16 can then be jammed against the mired wheel/tire and if necessary anchored in place with spikes 74. This will create a traction mat roadway upon which the vehicle can then safely travel un-mired in a desired direction (FIG. 4).

To further illustrate the invention without limiting same, the following dimensions are contemplated in producing a prototypical example of the traction mat apparatus of the invention:

Overall length: 44 in.
Overall width: 14 in.
Nominal wall thickness: 0.160 in.
Gripper member height: 0.250 in.
Storage box length: 32 in.

### Weight: 5.5 lbs

In retrospect, it will be appreciated that the present invention affords a novel apparatus for providing effective traction for a wheel or tire of a vehicle and like vehicles which is very easily and handily used, and can be economically manufactured and sold. Such a traction apparatus or device has numerous uses and can easily and successfully be utilized in any instance where it is desired to increase the traction between a driven wheel and the underlying roadway or other surface.

While particular embodiments of the invention have been illustrated and described in accordance with the Patent Statutes, it is not intended that the invention be limited to such disclosure. Numerous modifications and changes will readily occur to those skilled in the art and therefore, it is desired that the present invention be construed and limited only by the true spirit and scope of the annexed claims.

What is claimed as being new and desired to be protected by Letters Patent of the United States is as follows:

1. Vehicle traction mat apparatus comprising:
an elongated body member having a top surface,
gripper members for engagement with a vehicle wheel or tire,
wherein said gripper members are located on said top surface of said body member extending upright therefrom, and
at least one opening in said top surface for receiving an additional or replacement gripper member.

2. The apparatus of claim 1 further comprising a storage receptacle, said storage receptacle opening on said top surface of said elongated body member, said storage receptacle extending below said top surface of said elongated body member for containing various accessories which may be required during use of said apparatus without interfering with said gripper members extending upright therefrom, and wherein said various accessories includes said an additional or replacement gripper member.

3. The apparatus of claim 1 wherein said elongated body member further comprises inclined fore and aft edge portions proximal to corresponding fore and aft portions of said elongated body member top surface, respectively, for helping to wedge said elongated body member between the ground and the wheel or tire of a vehicle, and for providing first and second ramps for enabling said vehicle wheel or tire to roll onto and rest on said top surface of said elongated body member when said elongated body member is disposed between a ground surface and said vehicle wheel or tire.

4. The apparatus of claim 3 wherein said elongated body member is characterized by a raised top wall, a pair of fore and aft opposed inclined end walls, and a pair of opposed inclined side walls, said top surface being defined by said raised top wall, and said pair of fore and aft opposed inclined end walls defining said inclined fore and aft edge portions.

5. The apparatus of claim 4 wherein said elongated body member is fabricated of a stiff, durable molded polymeric material.

6. The apparatus of claim 5 wherein said polymeric material is glass-filled nylon.

7. The apparatus of claim 4 wherein the bottom of said elongated body member is a concave space bounded peripherally by a continuous annular ground-engaging rim formed by the common edge of said pair of opposed inclined side walls and said pair of fore and aft opposed inclined end walls, said concave space defining an interior elongated body member space disposed underneath said top surface defined by said top wall and wherein said interior elongated body member space disposed underneath said top surface defined by said top wall is further bounded by said pair of opposed inclined side walls and said pair of opposed inclined end walls.

8. The apparatus of claim 7 wherein said storage receptacle extending below said top surface of said elongated body member extends into said concave space defining an interior elongated body member space disposed underneath said top surface defined by said top wall.

9. The apparatus of claim 1 wherein said gripper members located on said top surface of said body member extending upright therefrom are positioned on said top surface spaced from each other in at least one row thereof extending longitudinally along said top surface of said elongated body member.

10. The apparatus of claim 9 wherein said at least one row of longitudinally extending gripper members spaced from each other form a tread section on said top surface proximal to said storage receptacle opening thereon.

11. The apparatus of claim 10 wherein each of said gripper members comprises a base portion having a generally triangular-shaped transverse cross-section and a protruding spike member extending upwardly from said base portion substantially centrally thereon.

12. The apparatus of claim 3 further including additional gripper members located on said first and second ramps, respectively.

13. The apparatus of claim 2 further including a removable cover for said storage receptacle opening.

14. The apparatus of claim 9 further including a plurality of openings provided in said top surface for receiving fastenable-in-place supplemental gripper elements to retread said body member when said first mentioned gripper elements are worn away from use.

15. The apparatus of claim 4 further including openings in said pair of fore and aft opposed inclined end walls to define carry handles for said elongated body member and to enable a plurality of elongated body members to be attached to each other end-to-end by cable ties to create a roadway.

16. The apparatus of claim 4 further including openings in said pair of fore and aft opposed inclined side walls to define carry handles for said elongated body member and to enable a plurality of elongated body members to be attached to each other side-to-side by cable ties to create a roadway.

17. The apparatus of claim 4 wherein said pair of inclined side walls each has an edge portion respectively, and at least one of said edge portions further includes a ground spike opening for receiving a ground spike to affix said elongated body member to the ground.

18. The apparatus of claim 2 wherein said various accessories contained in said storage receptacle is selected from the group consisting of cable ties, supplemental gripper members, ground spikes, or fasteners for affixing said supplemental gripper members on said elongated body member.
